(19) United States
(12) Patent Application Publication
(10) Pub. No.: US 2006/0059341 A1
(43) Pub. Date: Mar. 16, 2006

(54) Apparatus and method capable of network access

(76) Inventors: Abhay A. Dharmadhikari, Beaverton, OR (US); Mrudula Yelamanchi, Portland, OR (US); Jane Dashevsky, Beaverton, OR (US); Benjamin J. Matasar, Portland, OR (US); Selim Aissi, Beaverton, OR (US); Jose P. Puthenkulam, Beaverton, OR (US)

Correspondence Address: INTEL CORPORATION, P.O. BOX 5326, SANTA CLARA, CA, 95056-5326, US

(21) Appl. No.: 10/940,212

(22) Filed: Sep. 14, 2004

(51) Int. Cl. H04L 9/00

(52) U.S. Cl. 713/168

(57) ABSTRACT

An apparatus comprising at least one credential token interfaced with the apparatus and capable of enabling access by the apparatus to at least one network; and a peripheral link from the apparatus to at least one additional apparatus, wherein the at least one credential token enables access by the at least one additional apparatus to at least one additional network.

### BACKGROUND

In today's wireless environment numerous devices are present and may be connected wirelessly. For security and billing purposes, authorization to access a wireless network is an important element of such wireless environments. Currently, a device that is authenticated with a credential token must disconnect in order for the token to be reused. For example, a customer on a phone would have to hang up in order to connect to the internet with their account.

Thus, there is a continuing and strong need in the wireless industry to enable improved access to wireless networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of the components of one embodiment of the present invention;

FIG. 2 is an illustration of the method of operation and communication between the components of one embodiment of the present invention;

FIG. 3 is a flowchart illustrating a method of communication by a plurality of devices with a plurality of networks non-concurrently;

FIG. 4 is a flowchart illustrating a method of communication by a plurality of devices with a plurality of networks concurrently through the use of at least one credential token;

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. An apparatus may be specially constructed for the desired purposes, or it may comprise a general purpose computing device selectively activated or reconfigured by a program stored in the device. Such a program may be stored on a storage medium, such as, but not limited to, any type of disk including floppy disks, optical disks, compact disc read only memories (CD-ROMs), magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein. In addition, it should be understood that operations, capabilities, and features described herein may be implemented with any combination of hardware (discrete or integrated circuits) and software.

Use of the terms “coupled” and “connected”, along with their derivatives, may be used. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g. as in a cause an effect relationship).

It should be understood that embodiments of the present invention may be used in a variety of applications. Although the present invention is not limited in this respect, the devices disclosed herein may be used in many apparatuses such as in the transmitters and receivers of a radio system. Radio systems intended to be included within the scope of the present invention include, by way of example only, cellular radiotelephone communication systems, satellite communication systems, two-way radio communication systems, one-way pagers, two-way pagers, personal communication systems (PCS), personal digital assistants (PDA's), notebook computers in wireless local area networks (WLAN) or wide are networks (WAN), or personal area networks (PAN, and the like).

An embodiment of the present invention allows multiple devices using a single credential token to authenticate concurrently on two or more networks. The devices may facilitate this by integrating a peripheral link to each other in order to authenticate using the single credential token. It is understood that a credential token as used herein is an authentication mechanism and not limited to any existing protocols, standards or existing methodologies of providing authorization to any given network. Rather it is any now known or later developed ways to authenticate and authorize access to any type of network. Any of a variety of well-known peripheral links can be used, such as Bluetooth, Infrared Data Access (IRDA), etc. Although the present invention is not limited to these types of peripheral links.

In an embodiment of the present invention, the token and the network backend are capable of supporting concurrent network sessions. For example, and not by way of limitation, a notebook would be able to connect to an airport wireless local area network (WLAN) using the credential token present in the owner's mobile phone, which may be in a concurrent voice call.

The authentication may take place using the same or different credentials for both networks. In an embodiment of the present invention, these credentials may use authentication methods based on Public Key Cryptography, a shared secret, or both. Although the present invention is not limited to these authentication methods and it is anticipated that any now known or later developed authentication methods or cryptographic methods or any other methods of ensuring security may be utilized by the present invention. Because the authentication method may be preexisting, from the perspective of a service provider's business agreements and network infrastructure, integration may be readily facilitated. In this way the present invention may be capable of utilizing existing networks; although the present invention is not limited to using existing networks.

The present invention enables wireless devices to become more flexible with respect to network authentication, and for example, and not by way of limitation, PCs may gain the ability to roam and have session continuity, both traditionally advantages held by mobile phones. Users may be granted the ability to leverage certain characteristics of their devices that make them preferable for internet access, like large displays, processing power, and a full keyboard.

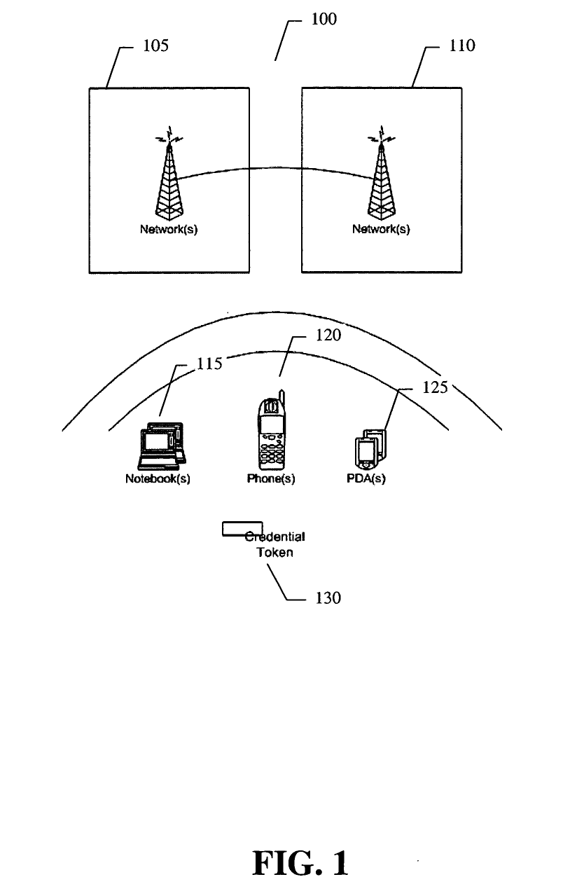

Turning now to the figures, FIG. 1, shown generally at 100, is an apparatus, such as notebook computer with communication (such as, but not limited to wireless communication) capabilities 125, Wireless Wide area network (WWAN) terminal 130 and personal digital assistant (PDA) with communication (such as, but not limited to wireless communication) capabilities 135 comprising at least one credential token 140 interfaced with the apparatus and capable of enabling access by the apparatus to at least one network 105; and a peripheral link from the apparatus to at least one additional apparatus, wherein the at least one credential token 140 enables access by the at least one additional apparatus to at least one additional network 110. The at least one network 105 and the at least one additional network 110 may communicate as shown at 115. It is understood that although an embodiment of the apparatus of the present invention is exemplified by a notebook computer or a mobile phone or a PDA, any device, wireless or otherwise, that may need access to a network be included in the present invention.

The at least one credential token may be one credential token 140 and the one credential token 140 may enable access to the at least one network by the apparatus and may enable access to the at least one additional network 110 by the at least one additional apparatus. In an embodiment of the present invention, the peripheral link may be a Bluetooth or Infrared Data Access (IRDA) link. Although the present invention is not limited in this respect as any method of communication, wireless, wired or otherwise, between apparatuses is within the scope of the present invention.

In an embodiment of the present invention, at least one credential token 140 may enable access by the apparatus to the at least one network 105 and the at least one additional apparatus access to the at least one additional network 110 by the at least one credential token 140 using authentication methods based on Public Key Cryptography, a shared secret, or both. Again, the present invention is not limited to these authentication methods. A backend 115, in one embodiment of the present invention, to the at least one network 105 and the at least one additional network 110, and the at least one token 140, may be able to support concurrent network sessions.

In an embodiment of the present invention, the at least one network 105 may be a Wireless Wide Area Network (WWAN) and the at least one additional network 110 may be a Wireless Local Area Network (WLAN) and the at least one credential token 140 may be interfaced with a WWAN terminal enabling access to the WWAN by the WWAN terminal, the at least one credential token 140 may further enable a computer access to the WLAN. In an embodiment of the present invention an authentication by the computer with the WLAN may happen through a WLAN access network using an EAP-SIM protocol or a EAP-AKA protocol. However, the present invention is not limited to these protocols. An example of one type of at least one credential token 140 may be at least one smart card. Although the present invention is intended to be limited to any particular type of credential token.

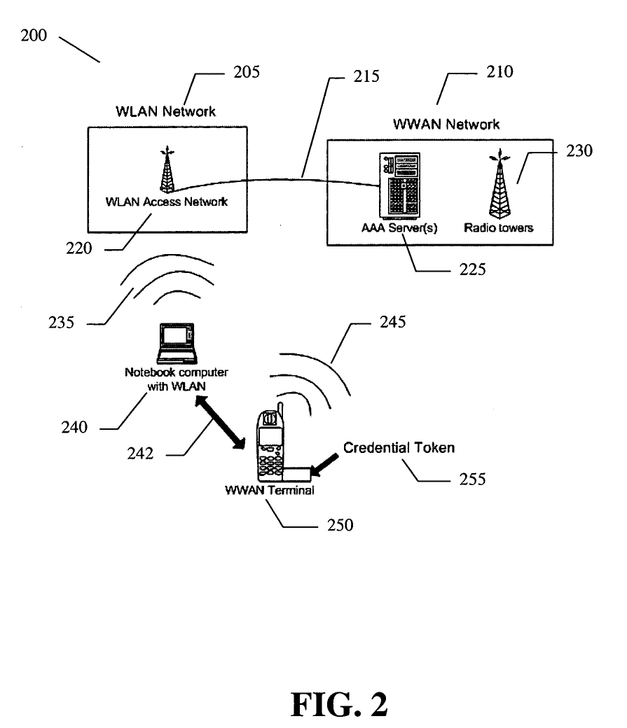

Turning now to FIG. 2 at 200 is a method of accessing a plurality of networks 205 and 210, comprising interfacing at least one credential token 255 with an apparatus, such as a wireless wide area network (WWAN) terminal 250 seeking access to at least one of the plurality of networks 205 and 210, the credential token 255 may be capable of enabling access by the apparatus 250 to at least one of the plurality of networks 205 and 210; and linking the apparatus 250 to at least one additional apparatus, such as notebook computer 240 with wireless 235 local area network (WLAN) access via access point 220, wherein the at least one credential token 255 enables access by the at least one additional apparatus 240 to at least one additional network 210 of the plurality of networks 205 and 210. Access point 220 may be in communication 215 with WWAN server 225 and thus when apparatus 250 is authorized by token 255 to use network 210 via radio tower 230, as it is a shared token, the at least one additional apparatus, such as WLAN capable notebook 240, may be authorized to utilize network 205 via access point 220.

The linking of the apparatus 250 and the at least one additional apparatus 240 may be accomplished via a Bluetooth or Infrared Data Access (IRDA) peripheral link 242. Although the present invention is not limited in this respect as any linking methodology, wired or wireless, may be utilized in the present invention.

As articulated above, in an embodiment of the present method the at least one credential token 255 enables access by the apparatus 240 to the at least one network 205 and the at least one additional apparatus 250 access to the at least one additional network 210 by the at least one credential token 240 using authentication methods based on Public Key Cryptography, a shared secret, or both. Again, the present invention is not limited to these authentication methods.

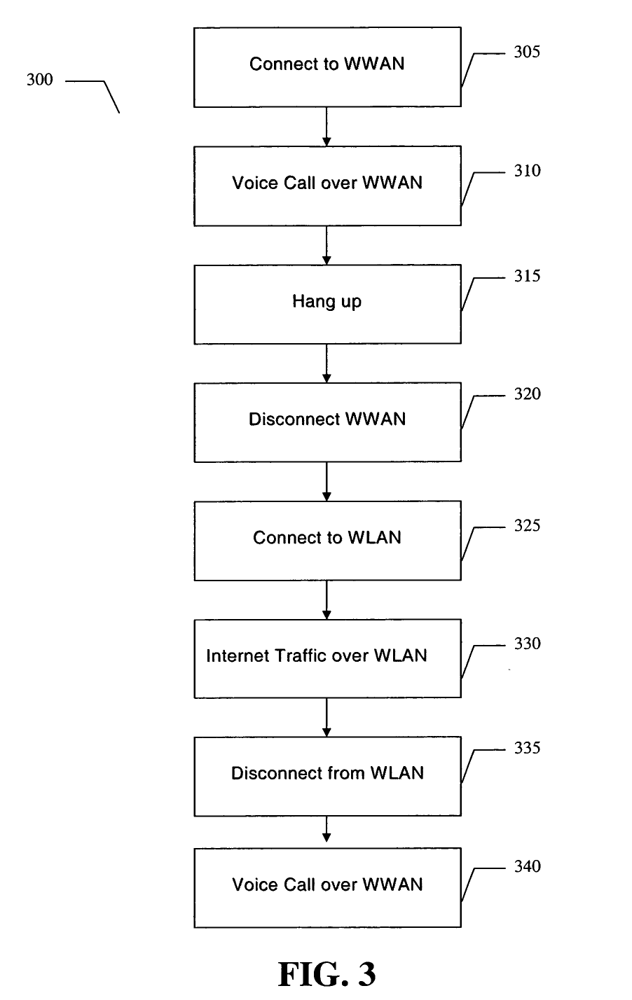

Turning now to FIG. 3, generally at 300, is an existing usage model (it is understood that any number of usage models are possible and within the scope of the present invention) for a user that wishes to make a voice call using, for example WWAN terminal 250, and connect their notebook computer with WLAN capabilities 240 to the internet. It includes: connecting to WWAN 305 with WWAN terminal 250; voice calling over WWAN 310 with WWAN terminal 250; hanging up 315; disconnecting from the WWAN 320; connecting to a WLAN 325 with notebook computer with WLAN access 240; interfacing with internet traffic over the WLAN 330; disconnecting from the WLAN 335; and voice calling using the WWAN 340 with WWAN terminal 250. As illustrated by this example, currently these actions must be arranged so the user must disconnect from one network to access another. This methodology can be cumbersome and time consuming.

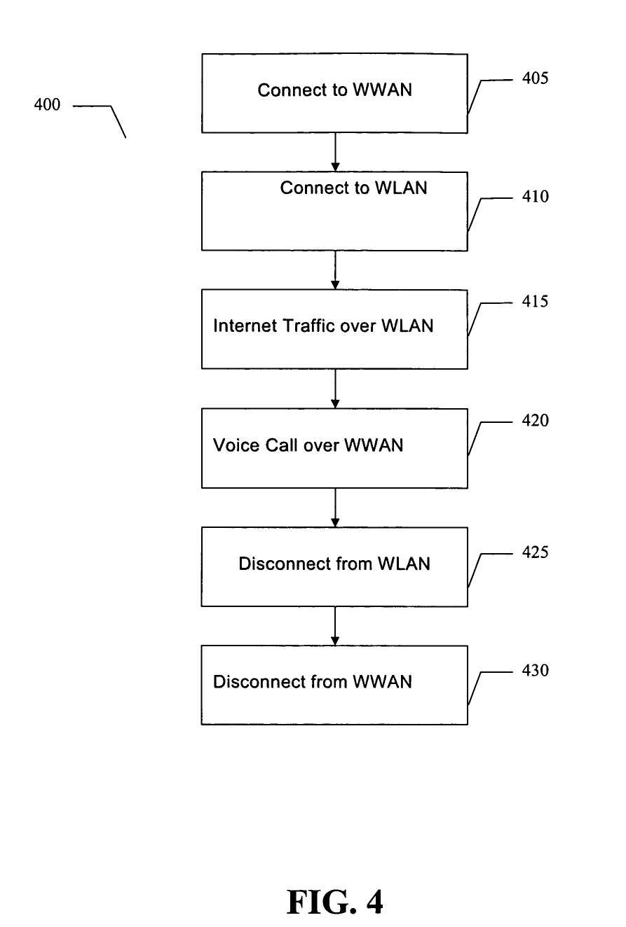

However, in one embodiment as shown in FIG. 4 at 400, the present invention allows for users to make a voice call using, for example WWAN terminal 250, and connecting their notebook computer with WLAN access 240 to the internet with their phone by simply: connecting to a WWAN 405 with WWAN terminal 250; connecting to a WLAN 410 with notebook computer with WLAN access 240; interfacing with internet traffic over the WLAN 415; voice calling over the WWAN 420 with WWAN terminal 250; disconnecting from the WLAN 425; and disconnecting from the WWAN 430. It is understood that the embodiments of FIG. 3 and FIG. 4 are merely examples of one method of using the present invention and are for illustrative purposes only. Any number and types of networks may be used as well as any number and types of apparatus as well as any number and types of authorization mechanisms which may include any number and types of security methods.

An embodiment of the present invention further provides an article comprising a storage medium having stored thereon instructions, that, when executed by a computing platform, results in the enabling of access to a plurality of networks 205 and 210 by a plurality of devices 240 and 250 by controlling the interfacing of at least one credential token 255 with an apparatus 250 seeking access to at least one of the plurality of networks 210, the credential token 255 capable of enabling access by the apparatus 250 to at least one of the plurality of networks 210; and controlling the linking 242 of the apparatus 250 to at least one additional apparatus 240, wherein the at least one credential token 255 enables access by the at least one additional apparatus 240 to at least one additional network 205 of the plurality of networks 205 and 210.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
at least one credential token interfaced with said apparatus and capable of enabling access by said apparatus to at least one network; and
a peripheral link from said apparatus to at least one additional apparatus, wherein said at least one credential token enables access by said at least one additional apparatus to at least one additional network.

2. The apparatus of claim 1, wherein said at least one credential token is one credential token and wherein said one credential token enables access to said at least one network by said apparatus and enables access to said at least one additional network by said at least one additional apparatus.

3. The apparatus of claim 1, wherein said peripheral link is a Bluetooth or Infrared Data Access (IRDA) link.

4. The apparatus of claim 1, wherein said at least one credential token enables access by said apparatus to said at least one network and said at least one additional apparatus access to said at least one additional network by said at least one credential token using authentication methods based on Public Key Cryptography, a shared secret, or both.

5. The apparatus of claim 1, wherein a backend to said at least one network and said at least one additional network, and said at least one token, are able to support concurrent network sessions.

6. The apparatus of claim 1, wherein said at least one network is a Wireless Wide Area Network (WWAN) and said at least one additional network is a Wireless Local Area Network (WLAN) and said at least one credential token is interfaced with a WWAN terminal enabling access to said WWAN by said WWAN terminal, said at least one credential token further enabling a computer access to said WLAN.

7. The apparatus of claim 6, wherein an authentication by said computer with said WLAN happens through a WLAN access network using an EAP-SIM protocol or a EAP-AKA protocol.

8. The apparatus of claim 1, wherein said at least one credential token is at least one smart card.

9. The apparatus of claim 1, wherein said at least one network and at least one additional network are capable of communication with each other.

10. A method of accessing a plurality of networks, comprising:
interfacing at least one credential token with an apparatus seeking access to at least one of said plurality of networks, said credential token capable of enabling access by said apparatus to at least one of said plurality of networks; and
linking said apparatus to at least one additional apparatus, wherein said at least one credential token enables access by said at least one additional apparatus to at least one additional network of said plurality of networks.

11. The method of claim 10, wherein said at least one credential token is one credential token and wherein said one credential token enables access to said at least one network by said apparatus and enables access to said at least one additional network by said at least one additional apparatus.

12. The method of claim 10, wherein said linking of said apparatus and said at least one additional apparatus is accomplished via a Bluetooth or Infrared Data Access (IRDA) peripheral link.

13. The method of claim 10, wherein said at least one credential token enables access by said apparatus to said at least one network and said at least one additional apparatus access to said at least one additional network by said at least one credential token using authentication methods based on Public Key Cryptography, a shared secret, or both.

14. The method of claim 10, further comprising linking said at least one network and at least one additional network thereby enabling communication between said at least one network and at least one additional network.

15. An article comprising a storage medium having stored thereon instructions, that, when executed by a computing platform, results in the enabling of access to a plurality of networks by a plurality of devices by controlling the interfacing of at least one credential token with an apparatus seeking access to at least one of said plurality of networks, said credential token capable of enabling access by said apparatus to at least one of said plurality of networks; and controlling the linking of said apparatus to at least one additional apparatus, wherein said at least one credential token enables access by said at least one additional apparatus to at least one additional network of said plurality of networks.

16. The article of claim 15, wherein said at least one credential token is one credential token and wherein said one credential token enables access to said at least one network by said apparatus and enables access to said at least one additional network by said at least one additional apparatus.

17. The article of claim 15, wherein said linking of said apparatus and said at least one additional apparatus is accomplished via a Bluetooth or Infrared Data Access (IRDA) peripheral link.

18. A system, comprising:
a first device;
a credential token interfaced with said first device, said token credential capable of enabling access to a first network by said first device; and
a second device with a peripheral link from said first device, wherein said at least one credential token enables access by said second device with a second network.

19. The system of claim 18, wherein said peripheral link is a Bluetooth or Infrared Data Access (IRDA) link.

20. The system of claim 18, wherein said first network and said second network are in communication with each other and said credential token enables access by said first and said second devices to said first and said second networks by using authentication methods based on Public Key Cryptography, a shared secret, or both.

21. The system of claim 18, wherein said credential token is a smart card.
